(19) United States
(12) Patent Application Publication
(10) Pub. No.: US 2009/0285112 A1
(43) Pub. Date: Nov. 19, 2009

(54) METHOD FOR MANAGING A RELAY PATH IN WIRELESS COMMUNICATION ENVIRONMENT

(75) Inventors: Yong-su Lee, Daejeon-city (KR); Hyukjoon Lee, Seoul (KR); Hyun Park, Seoul (KR); Young-Il Kim, Daejeon-city (KR); Young-Hoon Choi, Seoul (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute

(21) Appl. No.: 12/437,179

(22) Filed: May 7, 2009

Related U.S. Application Data
(63) Continuation of application No. PCT/KR2007/005598, filed on Nov. 7, 2007.

(30) Foreign Application Priority Data
Nov. 7, 2006 (KR) 10-2006-0109528
Nov. 7, 2007 (KR) 10-2007-0113125

(51) Int. Cl. H04L 12/26

(52) U.S. Cl. 370/252

(57) ABSTRACT

A method of managing a relay path in a mobile multi-hop relay (MMR) environment is provided. A relay station (RS) discovers a link quality of neighboring RSs, which is necessary for managing a path, and reports the link quality to a base station (BS). The BS selects an optimal path having a tree-structure based on the reported link quality and informs the RS. Thus, wireless resources can be efficiently used.

### CROSS REFERENCE TO RELATED APPLICATIONS

This application is a continuation of and claims the benefit of International Application No. PCT/KR2007/005598, filed Nov. 7, 2007, and claims the benefit of Korean Application No. 10-2006-0109528, filed Nov. 7, 2006, and Korean Application No. 10-2007-0113125, filed Nov. 7, 2006, the disclosure of all of which are incorporated herein by reference.

The present invention relates to a method of managing a relay path in a mobile multi-hop relay (MMR) environment, and more particularly, to a method of managing a multi-hop path, which has a tree-structure, between a base station (BS) and relay stations (RSs).

The present invention is derived from research which was supported by the ‘Information Technology (IT) Research and Development Program’ of the Ministry of Information and Communications (MIC) and the Institute for Information Technology Advancement (IITA), Republic of Korea. The project management number is ‘2006-S-01 1-01, and the title is ‘Development of relay/mesh communication system for multi-hop WiBro’.

### TECHNICAL FIELD

### Background Art

A Mobile Multi-hop Relay (MMR) environment is configured with a base station (BS), a mobile station (MS), and a relay station (RS) which relays a signal between the BS and the MS. Since technology for path management and routing has not been defined in the MMR environment so far, path re-setting due to an entry of a new RS or quality deterioration of an existing link is difficult.

### DESCRIPTION OF THE DRAWINGS

FIG. 1 is a diagram illustrating an example of a network topology having a tree-structure to which the present invention is applied;

FIG. 2, including 2A-2C, is a diagram illustrating a case in which a network topology is changed due to a new relay station (RS) entering an existing network;

FIG. 3, including 3A-3C, is a diagram illustrating a case in which a network topology is changed due to a link quality of an existing network changing;

FIG. 4 is a flowchart of a method of reporting a link quality for managing a relay path according to an embodiment of the present invention;

FIG. 5 is a flowchart of a method of optimizing a path for managing a relay path according to another embodiment of the present invention; and

FIG. 6 is a diagram illustrating an example of a path setting message for informing an optimal path set by a base station (BS).

### DETAILED DESCRIPTION OF THE INVENTION

### Technical Problem

The present invention provides a method of optimally managing a path between a base station (BS) and relay stations (RSs) when an entry of a new RS or quality deterioration of a link occurs in a mobile multi-hop relay (MMR) environment.

### Technical Solution

According to an aspect of the present invention, there is provided a method of reporting a link quality for path management in a wireless communication system by a relay station (RS), the method including the operations of recognizing a link quality between the RS and neighboring RSs; and transmitting a report message comprising the recognized link quality to a base station (BS).

According to another aspect of the present invention, there is provided a method of managing a path in a wireless communication environment by a BS, the method including the operations of obtaining a link quality of a RS; and selecting a path between the BS and the RS, based on the link quality.

### Advantageous Effects

According to the present invention, in the case where a network topology is changed due to a new relay station (RS) entering an existing network having a tree-structure or a quality of an existing link deteriorating, the present invention can optimally change and manage a path of the tree-structure.

### Best Mode

According to an aspect of the present invention, there is provided a method of reporting a link quality for path management in a wireless communication system by a relay station (RS), the method including the operations of recognizing a link quality between the RS and neighboring RSs; and transmitting a report message comprising the recognized link quality to a base station (BS).

According to another aspect of the present invention, there is provided a method of managing a path in a wireless communication environment by a BS, the method including the operations of obtaining a link quality of a RS; and selecting a path between the BS and the RS, based on the link quality.

### Mode for Invention

Hereinafter, a method of managing a path in a mobile multi-hop relay (MMR) environment and a system thereof according to the present invention will now be described more fully with reference to the accompanying drawings, in which exemplary embodiments of the invention are shown.

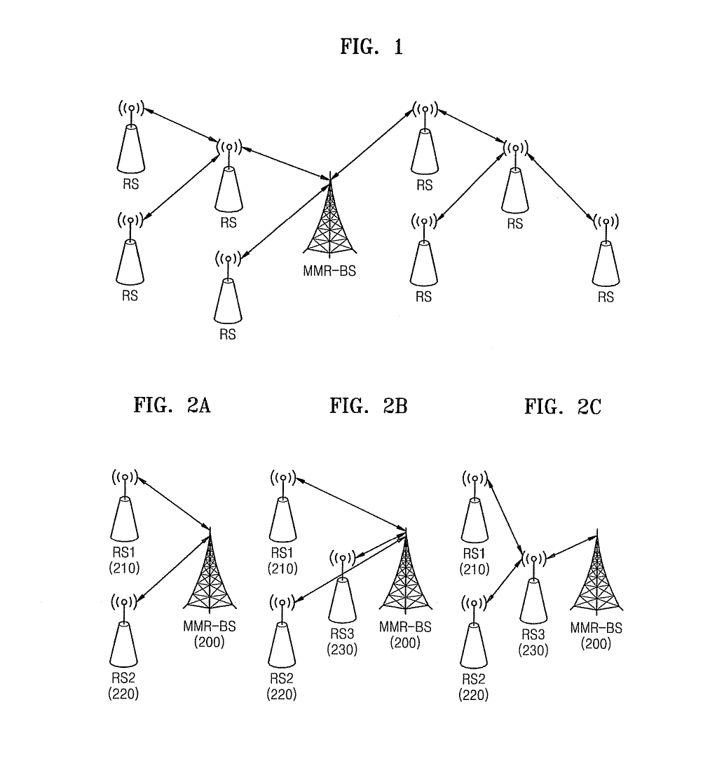

FIG. 1 is a diagram illustrating an example of network topology having a tree-structure to which the present invention is applied.

In general, a method of managing a multi-hop path between each of wireless stations is widely divided into the centralized method and the distributed method.

A base station (BS) can calculate end-to-end route quality metric for a multi-hop path between the BS and a relay station (RS) in a cell of the BS. Stability of link quality may be regarded as metric for selecting the multi-hop path. Route quality metric may be derived from the BS, based on link measurements obtained from a channel quality Indicator fast-feedback channel (CQICH).

A BS according to the present invention refers path metric which is determined by link quality information obtained from RSs controlled by the BS, thereby configuring and managing an optimal tree-structure in which the BS itself is a root.

Since traffic between each of Mobile Stations (MSs) cannot be transmitted by passing through only one or more RSs but has to be transmitted via the BS, and many control messages used in resources, a network entry, scheduling, etc, have to be transmitted forward or to the BS for centralization, the present invention configures and uses a tree topology as illustrated in FIG. 1.

A network having the tree-structure is gradually configured according to entries of new RSs. That is, a branch of the tree-structure is expanded when an RS newly enters the network. The newly entered RS may be directly connected to the BS or indirectly connected to the BS via a superordinate RS, by using a network entry procedure. The newly entered RS is connected to only one BS or only one superordinate RS which correspond to a parent node. In the case where the newly entered RS joins an existing network, a tree update may be required like in the case illustrated in FIG. 2.

FIG. 2 is a diagram illustrating a case in which a network topology is changed due to a new RS entering an existing network.

Referring to FIG. 2, when a third RS 230 that newly enters (FIG. 2B) the existing network (FIG. 2A) which is configured with a BS 200, a first RS 210, and a second RS 220, a tree update is required.

After entering the existing network, the third RS 230 discovers neighboring RSs (such as the first RS 210 and the second RS 220), thereby obtaining data regarding identifications (IDs), link quality, and the like which are related to the neighboring RSs. The data obtained by the third RS 230 is transmitted to the BS 200, thereby being used in a procedure for performing the tree update. The BS 200 updates a data structure indicating an optimal routing tree by using a shortest path algorithm such as Dijkstra's algorithm. Based on information regarding the optimal routing, the BS 200 informs the first, second, and third RSs 210, 220, and 230 of information regarding a parent node for each of the first, second, and third RSs 210, 220, and 230. Each of the first, second, and third RSs 210, 220, and 230 re-sets connection to the parent node that is newly recognized (FIG. 2C). The data is routed through a tree which is configured between the BS 200 and the first, second, and third RSs 210, 220, and 230 according to resource allocation.

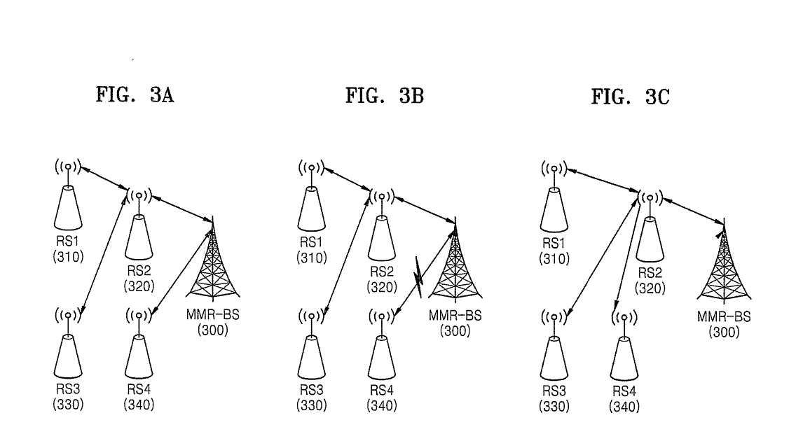

FIG. 3 is a diagram illustrating a case in which a network topology is changed since a link quality of an existing network is changed.

The case in relation to FIG. 3 is the case in which the network topology is changed not because a new RS enters the existing network but because link quality of an existing RS is changed. To be more specific, the existing network is configured with a BS 300, a first RS 310, a second RS 320, a third RS 330, and a fourth RS 340 (FIG. 3A). In the case where the link quality of a link between the BS 300 and the fourth RS 340 deteriorates due to an effect from environmental conditions (FIG. 3B), the BS 300 obtains information regarding such a link quality and re-configures an optimal tree excluding the link between the BS 300 and the fourth RS 340 (FIG. 3C). According to the optimal tree, the fourth RS 340 is connected in the form of a tree to the BS 300 via the second RS 320.

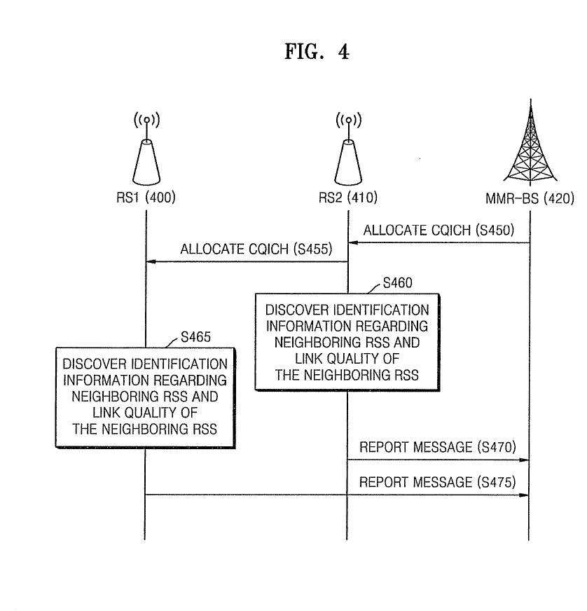

FIG. 4 is a flowchart of a method of reporting a link quality for managing a relay path according to an embodiment of the present invention.

Referring to FIG. 4, after a CQICH is allocated to a first RS 400 and a second RS 410 (operations S450 and S455), the first RS 400 and the second RS 410 transmit not only channel information of a link but also a report message, which will be described later, to a BS 420 via the allocated CQICH. In the case of centralized scheduling, a BS allocates the CQICH, for reporting a channel quality indicator (CQI) regarding a downlink transmission, to an RS in a cell of the BS. In the case of distributed scheduling, the BS and each of RSs allocate the CQICH to a downstream RS. For example, in the case of the distributed scheduling, the second RS 410 sets a unique uplink channel in an uplink sub-frame zone by using a CQICH allocation message (e.g., CQICH_allocation_IE( )) received from the BS 420, and the first RS 400 sets a unique uplink channel in an uplink sub-frame zone by using a CQICH allocation message (e.g., CQICH_allocation_IE( )) received from the second RS 410.

Each of the first and second RSs 400 and 410 receives downlink preamble information transmitted by neighboring RSs, thereby recognizing identification information (e.g., an RS ID, an RS address, preamble index, etc) and link quality information (e.g., carrier to interference and noise ratio (CINR), received signal strength indicator (RSSI), signal strength, etc) (operations S460 and S465). Such operations S460 and S465 may be performed by an RS neighborhood discovery procedure of a Table of Contents (ToC) which is defined by the Institute of Electrical and Electronics Engineers (IEEE) 802.16 relay group. The link quality information may be quality information regarding an uplink of an RS (R-UL), a downlink of an RS (R-DL), and a link between a BS and an RS or between RSs (R-Link). The CINR (that is an example of the link quality information) has a physical CINR value and an effective CINR value.

Each of the first and second RSs 400 and 410 transmits the report message including the identification information and the link quality information, which are for the neighboring RSs and which are obtained from the RS neighborhood discovery procedure, to the BS 420 via the CQICH which was previously allocated (operations S470 and S475). For example, since the first RS 400 is connected to the BS 420 via the second RS 410, the report message is transmitted to the BS 420 respectively via the CQICH between the first RS 400 and the second RS 410 and via the CQICH between the second RS 410 and the BS 420. Also, the report message of the second RS 410 is transmitted to the BS 420 via the CQICH between the second RS 410 and the BS 420.

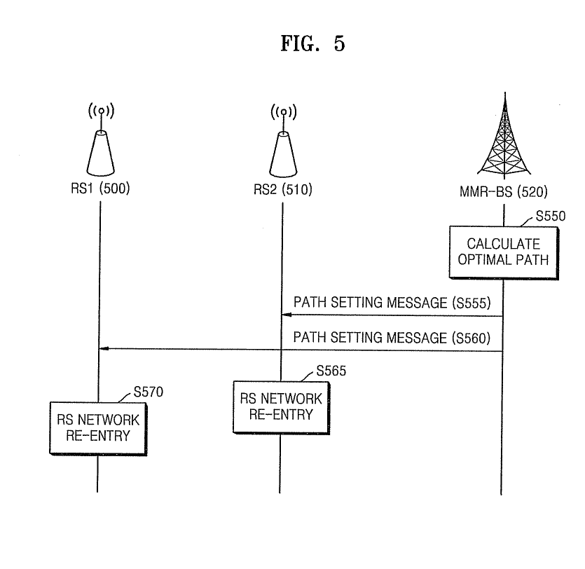

The BS 420 re-sets the tree-structure based on the report message obtained from each of the first and second RSs 400 and 410, and then transmits re-set information to each of the first and second RSs 400 and 410. This will now be described in relation to FIG. 5.

FIG. 5 is a flowchart of a method of optimizing a path for managing a relay path according to another embodiment of the present invention.

Referring to FIG. 5, a BS 520 calculates an optimal tree based on link quality information included in report messages (related to FIG. 4) which are reported by each of a first RS 500 and a second RS 510 (operation S550). The BS 520 newly sets a path between each of the first RS 500 and the second RS 510 so that a link cost, which is derived from a link quality value of each of the first RS 500 and the second RS 510, can be minimized, and updates an existing tree to the optimal tree having a shortest path. For this purpose, the BS 520 may use a shortest path algorithm such as Dijkstra's algorithm.

The BS 520 recognizes a parent node of each of the first RS 500 and the second RS 510 by using the calculated optimal tree, and broadcasts a path setting message including information regarding the recognized parent node of each of the first RS 500 and the second RS 510 to each of the first RS 500 and the second RS 510 (operations S555 and S560). A tree optimization message includes identification information regarding each of RSs whose parent node (that is, an RS or a BS) is changed, identification information regarding a parent node to be newly connected, and an optimal parameter indicating procedures which may be possibly omitted in an RS network re-entry procedure.

The first RS 500 and the second RS 510, which have received the tree optimization message, check whether their parent node has to be changed. Any one of the first RS 500 and the second RS 510 whose parent node has to be changed ends connection to a previous parent node and performs the RS network re-entry procedure, which comprises connecting to a new parent node (operations S565 and S570). At this time, in order to rapidly perform the RS network re-entry procedure, any one of the first RS 500 and the second RS 510 whose parent node has to be changed may omit some procedures from among the RS network re-entry procedure, based on the optimal parameter included in the tree optimization message. Examples of the procedures that can be omitted are an RS basic capability REG/RSP procedure, an RS registration REQ/RSP procedure, an address acquisition procedure, and the like.

Any one of the first RS 500 and the second RS 510 whose parent node is to be changed may end the connection to the previous parent node and perform the RS network re-entry procedure after waiting a predetermined time. The reason for waiting the predetermined time is that any one of the first RS 500 and the second RS 510 whose parent node is to be changed has to wait for all RSs to end connection to a parent node of all RSs. If any one of the first RS 500 and the second RS 510 whose parent node is to be changed does not wait the predetermined time until all RSs ends the connection to the parent node, the RS network re-entry procedure may be performed to a node which is connected in a downlink direction.

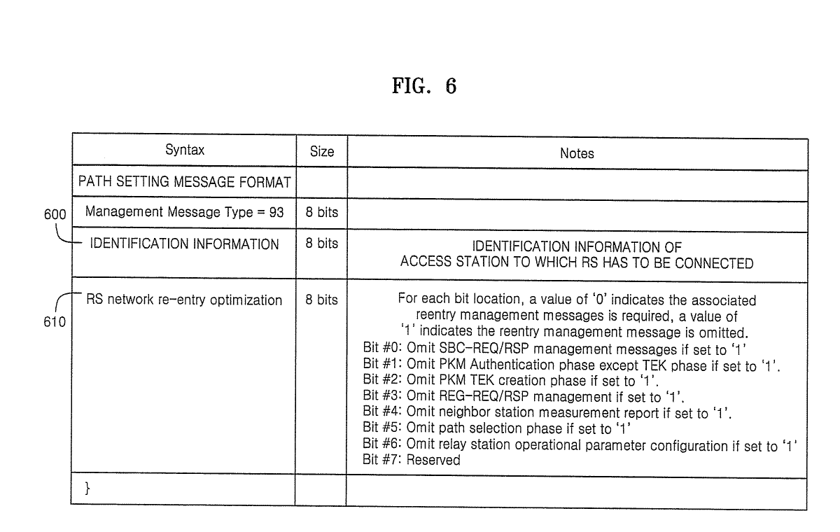

FIG. 6 is a diagram illustrating an example of a path setting message for informing an optimal path set by a BS.

Referring to FIG. 6, the BS broadcasts the path setting message to a cell, thereby informing each of RSs of the optimal path about a tree-structure which is newly set. The path setting message includes identification information 600 regarding an access station (that is, the BS or an RS) to which an RS has to be newly connected and information 610 regarding procedures that can be omitted from among an RS network re-entry procedure. A preamble index of the access station may be used as the identification information 600 regarding an access station.

The invention can also be embodied as computer readable codes on a computer readable recording medium. The computer readable recording medium is any data storage device that can store programs or data which can be thereafter read by a computer system. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet). The computer readable recording medium can also be distributed over network coupled computer systems so that the computer readable code is stored and executed in a distributed fashion.

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

1. A method of reporting a link quality for path management in a wireless communication system by a RS (relay station), the method comprising:
recognizing a link quality between the BS and RS and the BS and neighboring RSs; and
transmitting a report message comprising the recognized link quality to a BS (base station).

2. The method of claim 1, wherein the transmitting of the report message comprises transmitting the report message via a CQICH (channel quality Indicator channel).

3. The method of claim 1, wherein the report message comprises the link quality and identification information regarding the neighboring RSs.

4. The method of claim 1, further comprising performing a network re-entry of a station, which has to be newly connected, by the RS according to path information received from the BS.

5. The method of claim 1, wherein the link quality comprises a CINR (carrier to interference and noise ratio). (CINR or (and) RSSI)

6. A method of managing a path in a wireless communication environment by a BS, the method comprising:
obtaining a link quality between the BS and RS and the RS and neighboring RSs; and
selecting a path between the BS and the RS, based on the link quality.

7. The method of claim 6, wherein the obtaining of the link quality comprises obtaining a link quality between the BS and RS and the RS and neighboring neighboring RSs.

8. The method of claim 6, wherein the obtaining of the link quality comprises obtaining the link quality via a CQICH which is allocated to the RS.

9. The method of claim 6, wherein the selecting of the path comprises selecting a path having a tree structure, in which the BS is a root.

10. The method of claim 9, wherein the selecting of the path comprises selecting the path having the tree structure by using a shortest path algorithm.

11. The method of claim 6, further comprising recognizing an access station to which the RS has to be connected based on the selected path and transmitting a path setting message comprising identification information regarding the access station.

12. The method of claim 11, further comprising transmitting the path setting message comprising information regarding procedures that can be omitted from among procedures for a network re-entry to the access station.

13. A computer readable recording medium having recorded thereon a program for executing a method of managing a path in a wireless communication environment, the method comprising:
recognizing a link quality of neighboring RSs which neighbor the RS; and
transmitting a report message comprising the recognized link quality to the BS

14. A computer readable recording medium having recorded thereon a program for executing a method of managing a path in a wireless communication environment by a BS, the method comprising:
obtaining a link quality of a RS; and
selecting a path between the BS and the RS, based on the link quality.
